(19) United States
(12) Patent Application Publication
(10) Pub. No.: US 2008/0267395 A1
(43) Pub. Date: Oct. 30, 2008

(54) APPARATUS AND METHOD FOR ENCRYPTED COMMUNICATION PROCESSING

(75) Inventor: Satoshi Deishi, Ibaraki-shi (JP)

Correspondence Address: SIDLEY AUSTIN LLP, 717 NORTH HARWOOD, SUITE 3400, DALLAS, TX, 75201, US

(73) Assignee: Konica Minolta Holdings, Inc., Tokyo (JP)

(21) Appl. No.: 12/107,279

(22) Filed: Apr. 22, 2008

(30) Foreign Application Priority Data
Apr. 26, 2007 (JP) 2007-116573

(51) Int. Cl. H04L 9/06

(52) U.S. Cl. 380/44

(57) ABSTRACT

To provide an apparatus and a method for encrypted communication processing in inter-node communication on a network capable of performing effective encrypted communication with improved security. In the inter-node multicast communication on the network, by first setting one or more of encryption keys, it can be avoided to deteriorate, by the procedure for an encrypted communication, the condition where the multicast communication is possible. Therefore, the multicast by the effective encrypted communication with improved security becomes possible.

This application is based on Japanese Patent Application No. 2007-116573 filed on Apr. 26, 2007, in Japanese Patent Office, the entire content of which is hereby incorporated by reference.

### TECHNICAL FIELD

The present invention relates to an apparatus and a method for executing encrypted communication between encrypted communication processing apparatuses constituting a network as a node.

### BACKGROUND

In recent years, a network having a communication form for freely transmitting and receiving data between any nodes constituting the network has been used actively.

As a typical form, there is available a form of communication network called P2P (Peer to Peer). The P2P is a form of usage of a network for transmitting and receiving information directly between an indefinite number of nodes, and some forms of the P2P technically needs an intermediation of a central server or uses a bucket relay system to transfer data.

In such a distributed processing network system, such a communication form is frequently used where transmission to a plurality of nodes at the same time is performed like multicast in the case of searching a node, gathering a log, or inquiring data.

However, every time a direct connection between any nodes is established to transmit and receive data, a procedure for that connection is necessary to be done. In some procedures, decrease in communication speed may be caused, and a communication form such as multicast may be impossible. On the other hand, if a procedure for freely executing communication between any nodes is made as simple as possible, and the multicast communication is made to be available, the danger to security such as interception of communication by a third party is apt to increase.

For example, as a typical communication protocol used for the Internet, there are the TCP (Transmission Control Protocol) and UDP (User Datagram Protocol), and they have advantages and disadvantages as mentioned above. To be specific, the TCP is excellent in security and credibility, however, due to its procedures, a multicast communication can be realized. Further, although a multicast communication is available in the UDP, the security and reliability of communication are low because the procedures are simplified.

To enhance the security of communication, the encryption process is often used generally. In a protocol such as the UDP where the multicast communication is available, the security of communication may be enhanced by adding the encryption process.

As an encrypted communication protocol which is often used generally, the IPsec (security architecture for internet protocol) and SSL (secure socket layer) may be cited, however, these are the protocols that function on the TCP where a multicast communication is not available.

As it is difficult to perform an effective encryption process while making a multicast communication possible, an art for enhancing the security without using encryption is proposed (for example, refer to Unexamined Japanese Patent Application Publication 2005-303784).

The art disclosed in Unexamined Japanese Patent Application Publication 2005-303784 identifies the communication partner by confirming the ID of the correspondent node accessed for communication and rejecting the ID if it is not the predetermined ID. However, it is easy to spoof by acquiring the ID through Brute force attack or capturing packet. Further, since it is not an encryption process, it can easily get into the communication contents by spoofing.

In a protocol such as the UDP where a multicast communication is available, desirable is an encryption process which functions without complicating the procedure and making a multicast communication impossible. As such a encryption process, an encryption process using a fixed shared key has been conventionally used.

In the encryption processing technology using the fixed shared key, the nodes on the transmitting and receiving sides hold a shared encryption key (that is, the same key is used for encryption and decryption) and the key is fixed and unchanged.

However, there are problems that the shared key is easy to guess the shared key because it is always the same in the encryption processing method using the fixed shared key, or the communication can be easily intercepted by using an encryption processing.

There is desired an encryption processing technology that improves the security without complicating the procedures, in other words, without making the multicast communication impossible.

As mentioned above, the multicast communication and security are hardly compatible with each other in the inter-node communication on the network. Although it is desirable to execute communication by using encryption for security, it is difficult to perform the effective encrypted communication processing while keeping the multicast communication possible.

### SUMMARY

An object of the present invention is to solve the aforementioned problems and to provide an encrypted communication processing method and an encrypted communication processing apparatus as a node. The method and apparatus are capable of the multicast communication by an effective encryption with improved security in inter-node communication on a network.

In view of forgoing, one embodiment according to one aspect of the present invention is a method for encrypted communication process for performing encrypted communication between a plurality of nodes constituting a network system, the method comprising the steps of:

determining a message number between a first node and a plurality of second nodes on a receiving side;

causing the first node to authenticate each of the second nodes;

communicating a first information for generating an encryption key between the first node and the each of the second nodes when the first node has successfully authenticated the each of the second nodes;

generating an encryption key based on the first information to share the encryption key between the first node and the second nodes;

causing the first node to encrypt a second information based on the encryption key and to multicast to the second nodes a message and the message number, the message including the encrypted second information.

According to another aspect of the present invention, another embodiment is an encrypted communication processing apparatus as a node of a network system for performing encrypted communication between a plurality of nodes, the apparatus comprising:

a determination section which is adapted to determine a message number between the apparatus and a plurality of other nodes;

an authentication section which is adapted to authenticate each of the other nodes based on first information received from the plurality of other nodes;

an encryption key generating section which is adapted to, when the each of the plurality of other nodes has been successfully verified, communicate a second information for generating an encryption key to the plurality of other nodes, to generate an encryption key based on the second information, and to share the encryption key between the apparatus and the plurality of other nodes; and

an encrypting section which is adapted to encrypt a third information based of the encryption key and to multicast to the plurality of other nodes a message and the message number, the message including the encrypted third information.

### BRIEF DESCRIPTION OF THE DRAWINGS

FIG. 1 is a drawing showing an entire constitution example of a network 1 according to an embodiment of the present invention;

FIG. 2 is a drawing showing a hardware constitution example of a node (encrypted communication processing apparatus) 2 constituting the network 1 according to the embodiment of the present invention;

FIG. 3 is a drawing showing a connection form of each of the nodes 2 constituting the network 1 according to the embodiment of the present invention, that is, a theoretical topology example of the nodes;

FIG. 4 is a drawing showing the examples of the connection table TL of the nodes 2 associated as shown in FIG. 3;

FIG. 5a is a block diagram showing a function constitution example of the node (encrypted communication processing apparatus) 2;

FIG. 5b is a drawing showing an internal constitution of the function of a authentication section 205;

FIG. 6 is a sequence diagram for describing a processing example when establishing connection of SSL communication in the embodiment of the present invention;

FIG. 7 is a flow chart showing a typical flow of the encrypted communication processing from establishment of encrypted communication according to the embodiment of the present invention to the multicast transmission of data;

FIG. 8 is a sequence diagram showing a detailed flow of the processing example of the connection step shown in FIG. 7;

FIG. 9 is a sequence diagram showing a detailed flow of the processing example of the authentication step shown in FIG. 7;

FIG. 10 is a sequence diagram showing a detailed flow of the processing example of the encryption key generating step shown in FIG. 7;

FIG. 11 is a sequence diagram showing a detailed flow of the processing example of the encryption step shown in FIG. 7;

FIG. 12 is an explanatory diagram showing an example of a multicast transmission, from the PC1 to the PC2 and PC3, of data encrypted by an encryption key shared between them;

FIG. 13 is an explanatory diagram showing an example of transmitting encrypted return data from the PC3 to the PC1;

FIG. 14 is an explanatory diagram showing an example of a multicast transmission, from the PC1 to the PC2 and PC3, of data encrypted by a selected shared encryption key; and

FIG. 15 is a diagram showing an example of the situation where massage numbers and shared encryption keys are stored in a memory in the case of a multicast transmission from the PC1 to the PC2 and PC3.

### DETAILED DESCRIPTION OF THE PREFERRED EMBODIMENT

Hereinafter, the embodiment of the present invention will be explained with reference to the accompanying drawings.

### [Entire Constitution of the Network]

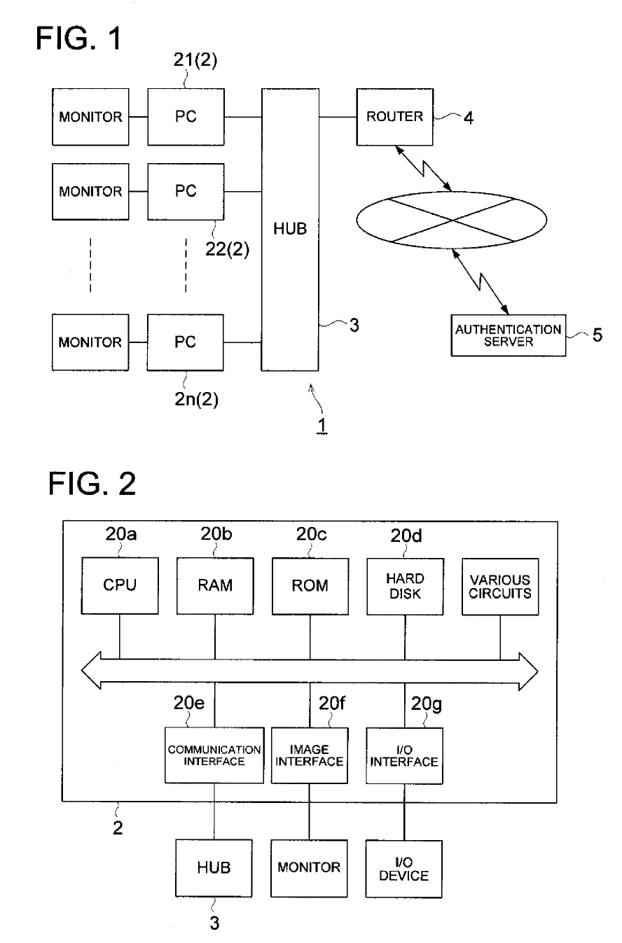

FIG. 1 is a drawing showing the entire constitution example of a network 1 composed of the encrypted communication processing method and encrypted communication processing apparatus according to the embodiment. By referring to FIG. 1, the entire constitution of the network 1 according to the embodiment of the present invention will be explained.

The network 1 according to the embodiment of the present invention, as shown in FIG. 1, is a LAN (local area network) composed of nodes such as a plurality of terminal devices 2 (21, 22, - - - , 2n), a switching hub 3, a router 4, and an authentication server 5. The terminal devices 2 are connected to the switching hub 3 by twisted pair cables in a star shape.

The terminal devices 2 as nodes constituting the network are an encrypted communication processing apparatus according to the present invention, which executes a data I/O process by encrypted communication between itself and another device such as a personal computer, a work station, or a printer. Hereinafter, a description will be made assuming that a node is just referred to as this terminal and a personal computer is used as the node.

Further, in this embodiment, a form of a communication network called a P2P (Peer to Peer) is adopted. The P2P is a form usage of a network for directly transmitting and receiving information between many and indefinite number of nodes, and there are two kinds of forms such as a form technologically requiring intermediation of a central server and a form for transferring data in a bucket brigade system. When the central server is required, it only provides a file search data base and controls connection of nodes, and transfer of data is executed through direct connection between the nodes.

Further, even in a form that the central server performs an integrated processing as a host, there is also a system which can be occasionally changed such that any client functions as the central server. Such a network can be seen to practically have the same function as the P2P system in which direct transmission and reception of data between indefinite number of nodes is executed.

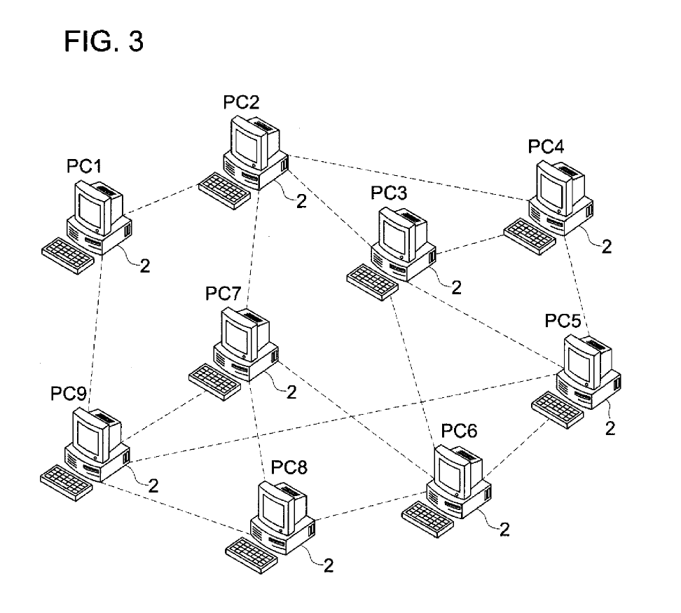

In this embodiment, the central server is not used, and the connection topology shown in FIG. 3 will be described later, where the direct connection and communication between the nodes (encrypted communication processing apparatuses) 2 associated with each other beforehand is executed. The connection between the nodes not associated with each other beforehand is to be established via the directly connected nodes. The authentication server 5 executes only the management related to a certificate for authentication and does not directly participate in the connection for communication. Further, also the router 4 does not participate in communication between the nodes (encrypted communication processing apparatuses).

In the P2P, because the nodes mutually execute communication directly, important is a security of verifying mutual justification in some way or decreasing room for unauthorized access. Therefore, a digital certificate issued by the authentication server 5 is used. In the encrypted communication processing which will be described later, the digital certificate of the specification X.509 is used. Regarding authentication using the digital certificate, refer to IETF RFC2459, “Internet X.509 Public Key Infrastructure Certificate and CRL Profile”.

If the validity of the digital certificate has expired or the reliability of the digital certificate is impaired due to loss or robbery of the secret key, the certificate authority posts it on the certificate revocation list (CRL) to open to the public, thus it looses its effect.

Hereinafter, on the network according to this embodiment, there is described, from the aforementioned viewpoint, the case in which these nodes 2 establish mutual connection for encrypted communication and mutually transmit and receive information by encryption.

### [Constitution of the Encrypted Communication Processing Apparatus]

FIG. 2 is a drawing showing an example of the hardware constitution of the node (encrypted communication processing apparatus) 2.

The node 2, as shown in FIG. 2, is composed of a CPU 20a, a RAM 20b, a ROM 20c, a hard disk 20d, a communication interface 20e, an image interface 20f, an I/O interface 20g, and other various circuits or devices.

The communication interface 20e is, for example, an NIC (Network Interface Card) and is connected to either port of the switching hub 3 via a twisted pair cable. The image interface 20f is connected to a monitor and sends a video signal for displaying to the monitor.

The I/O interface 20g is connected to an input device such as a keyboard or a mouse or an external storage device such as a CD-ROM drive. And the interface inputs from the input device a signal indicating the contents of the operation performed by a user to the input device. Or, the interface permits the external storage device to read the data recorded in the recording medium of the CD-ROM or the like and inputs it. Or, the interface outputs data to be written into the recording medium to the external storage device.

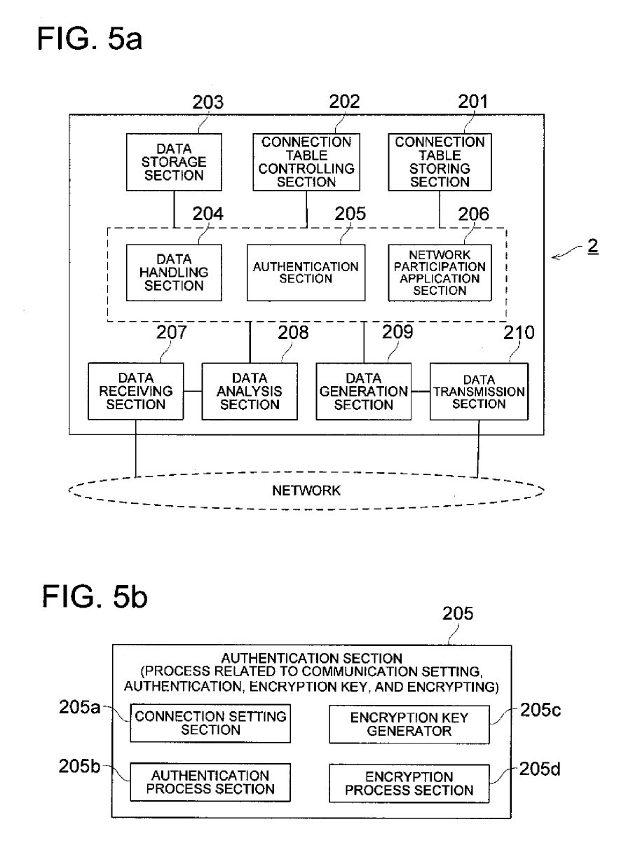

In the hard disk 20d, as will be described later by referring to the function block diagrams (FIGS. 5a and 5b), stored are the programs and data for realizing the functions of a connection table storing section 201, a connection table controlling section 202, a data storage section 203, a data handling section 204, a authentication section 205, a network participation application section 206, a data receiving section 207, a data analysis section 208, a data generation section 209, and a data transmission section 210 or the like. These programs and data are loaded into the RAM 20b as required, and the programs are executed by the CPU 20a.

To each of the nodes 2, for discrimination from the other nodes 2, the host name (machine name), IP address, and MAC address are given. The host name can be decided freely by the manager of the network 1. The IP address is given according to the regulations of the network 1. The MAC address is an address given fixedly to the communication interface 10e of the concerned node 2.

In this embodiment, to the nodes (encrypted communication processing apparatuses) 21, 22, - - - , the host names such as PC1, PC2, - - - are assumed to be assigned. Hereinafter, the nodes 2 may be mentioned by the host names.

### [Connection Form of the Nodes]

FIG. 3 is a drawing showing the connection form of the nodes, that is, a theoretical topology example of the nodes 2. The connection form of the nodes (encrypted communication processing apparatuses) will be described by referring to FIG. 3.

The nodes 2, as shown in FIG. 3, are assumed to be arranged in a virtual space. And, as shown by the dotted lines, each node is associated with at least another neighboring node in the virtual space. Moreover, by this association, all the nodes 2 are associated with each other directly or indirectly.

Further, “to be directly associated” is referred to as being coupled by single dotted line in FIG. 3 (for example, the relationship between PC1 and PC2 or PC9 shown in FIG. 3), and “to be indirectly associated” is referred to as being coupled via at least two dotted lines and one node (for example, the relationship between PC1 and PC4 shown in FIG. 3). The nodes 2 transmit data to other nodes 2 directly associated with themselves.

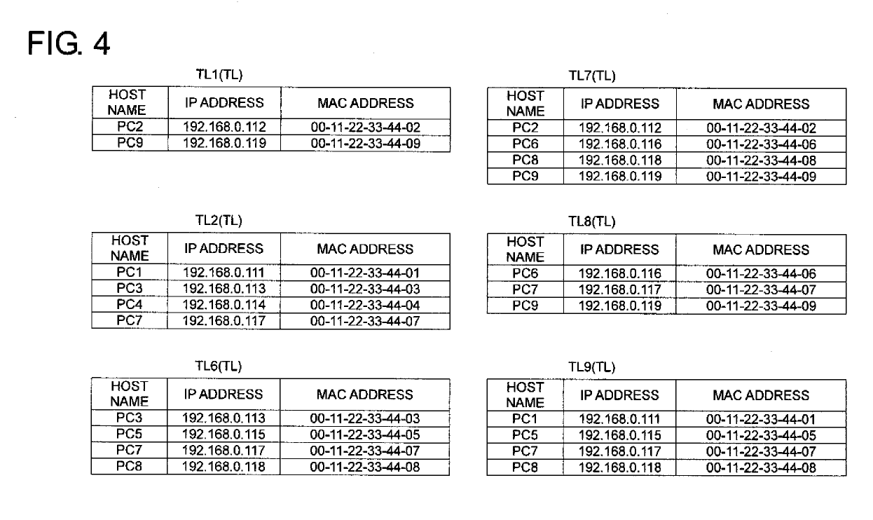

FIG. 4 is drawings showing the examples of the connection table TL of the nodes 2 associated as shown in FIG. 3. Each of the tables TL holds in table form a list of information for connection with other nodes 2 “associated directly” to which the each node can directly transmit data.

For example, in the PC1, PC2, PC6, PC7, PC8, and PC9 shown in FIG. 3, the connection tables TL1, TL2, TL6, TL7, TL8, and TL9 as shown in FIG. 4 are held respectively.

### [Function of Each Section of the Encrypted Communication Processing Apparatus]

FIG. 5a is a block diagram showing a functional constitution example of the node (encrypted communication processing apparatus) 2. The processing function of each section of the node 2 will be described by referring to FIG. 5a.

The connection table storing section 201 stores the connection table TL indicating a list of the attributes such as the host name, IP address, and MAC address of another node 2 with which the node 2 itself is directly associated. For example, an example of the connection table stored in the connection table storing section 201 of each node is described already by referring to FIG. 4. The contents of these connection tables TL are generated beforehand by the manager on the basis of the association of the respective nodes 2.

The connection table controlling section 202 controls the connection table TL stored in the connection table storing section 201 aforementioned.

The data storage section 203 stores attribute data indicating the attributes of the concerned node 2 or a user, data used in a digital certificate of the concerned node 2 itself, a certificate revocation list (CRL), data used in an operating system (OS) or application software, data generated by the user using the application software, data such as an encryption key necessary to perform the encrypted communication processing, and the other various data as a file.

The digital certificate is issued by the authentication server 5 upon request of a node 2, is stored by the concerned node 2, and is used to authenticate mutually at the time of communication of nodes 2. The certificate revocation list (CRL) registers and records the revocation of the digital certificate due to secession of the concerned node and is controlled by the authentication server 5.

The data handling section 204 stores data in the data storage section 203 and performs a process of updating the data stored in the data storage section 203. For example, whenever the environment of the node 2 or the setting contents thereof are changed, the data handling section 204 updates the attribute data.

Further, the data handling section 204 processes and temporarily stores data (information) acquired from other nodes.

The authentication section 205, on the basis of a digital certificate transmitted from another node 2, performs the authentication process for the concerned another node 2. Further, it inquires the authentication server 5 to confirm whether the transmitted digital certificate has been revoked or not.

Further, the authentication section 205 performs a process for establishment of encrypted communication with other nodes and a process for the encrypted communication. The details will be described later.

The network participation application section 206 performs a process for the concerned node 2 to newly participate in the network or to escape it.

The data handling section 204, authentication section 205, and network participation application section 206 execute, whenever necessary, data communication with other nodes 2 of the network 1 via the data receiving section 207 and data transmission section 210, and whenever necessary, refer to or update the data of the connection table storing section 201 and data storage section 203.

FIG. 5b is a drawing showing the internal constitution of the function of the authentication section 205. By referring to FIG. 5b, the function of the authentication section 205, that is, the functions of the processes for establishment of encrypted communication with other nodes and the encryption processing will be described.

The authentication section 205 includes a connection setting section 205a for functioning as a connection section for exchanging message numbers and an authentication process section 205b for functioning as an authentication section for transmitting and receiving information necessary to authenticate each node and authenticating it.

Further, the authentication section 205 includes an encryption key generator 205c for functioning as an encryption key generating section for transmitting and receiving information for generating an encryption key, for generating the encryption key, and for sharing it, and an encryption process section 205d for functioning as an encrypting section for executing data communication which is encrypted on the basis of the encryption key.

The functions of the connection setting section 205a, authentication process section 205b, encryption key generator 205c, and encryption process section 205d will be described in detail together with the encrypted communication processing flow to be described later.

By referring to FIG. 5a again, the description of each section of the node (encrypted communication processing apparatus) 2 will be continued.

The data receiving section 207 performs the control process for executing data communication with other nodes 2. The data receiving section 207, among the packets flowing in the network 1, receives ones necessary for the node 2.

The data analysis section 208, from the data received by the data receiving section 207, extracts necessary information, analyzes the contents thereof, thereby discriminates the kind of the received data.

The data generation section 209 generates transmission data to be transmitted to other nodes 2 on the basis of an instruction of the data handling section 204, authentication section 205, network participation application section 206 or the like.

The data transmission section 210 transmits transmission data which is generated and converted into packet by the data generation section 209 to other nodes 2.

### [Inter-Node SSL Communication]

The nodes 2 of this embodiment is supposed to use a simplified communication form without establishing session such as the UDP to maintain high-speed communication between itself and another plurality of nodes 2 associated with directly or indirectly. Therefore, the general SSL (Secure Socket Layer) communication can not be employed. However, the SSL is related to the process flow of establishing an encrypted communication of the embodiment because the SSL is a protocol for safe transmission and reception of data on the network by encryption and authentication using the digital certificate.

First, the process of establishing the SSL communication will be described bellow.

Note that the standard specifications of the general digital certificate and certificate revocation list (CRL) are defined as X. 509 by the ITU (International Telecommunication Union). In the following description of the SSL communication, the digital certificate will be referred to as X. 509 certificate.

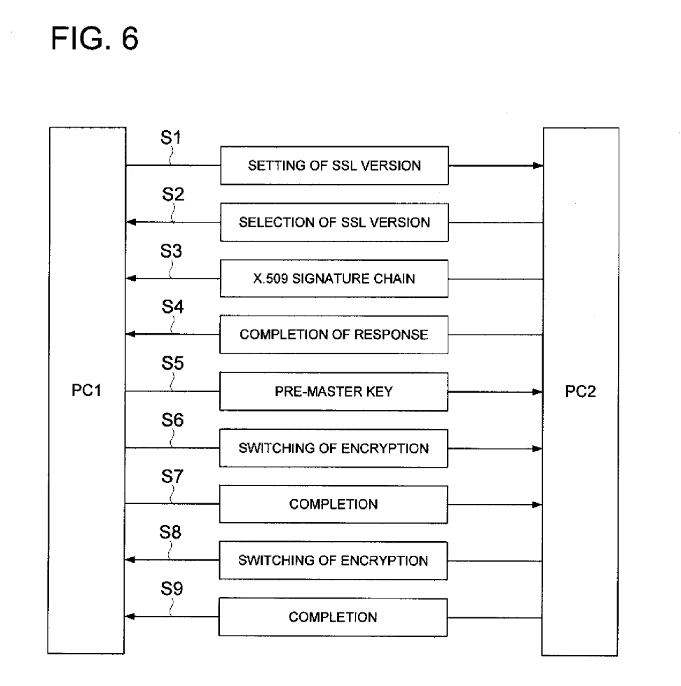

FIG. 6 is a drawing illustrating an example of the processing flow when establishing connection of the SSL communication in this embodiment. The case that the nodes shown in FIG. 3, for example, the PC1 and PC2 are about to execute the target communication will be described as an example in more detail by referring to FIG. 6.

As a preceding stage of connection establishment of the SSL communication, the connection itself is established. Firstly, it is assumed that a user inputs by operating the keyboard a command indicating, for example, that the PC1 is caused to communicate with the PC2. Then, the data generation section 209 generates connection request data, and the data transmission section 210 transmits the connection request data to the node PC2.

Then, in the PC2, the data receiving section 207 receives the connection request data from the PC1, and the data analysis section 208 analyzes the kind of the data. Here, needless to say, it is analyzed as connection request data. The data generation section 209 generates connection permission data indicating permission of connection, and the data transmission section 210 transmits it to the PC1.

The connection permission data is received by the data receiving section 207 of the PC1, and then the predetermined process is performed to establish the connection between the PC1 and the PC2. However, at this point of time, the connection of the SSL communication is not established yet, and then, the program enters the flow of connection establishment of the SSL communication.

Firstly, in either of the PC1 and PC2, the data generation section 209 generates SSL version data indicating the compatible versions of the SSL, and the data transmission section 210 transmits it to the other node (Step S1). In FIG. 6, it is assumed that the PC1 transmits the SSL version data to the PC2.

Then, in the PC2, the data receiving section 207 receives the SSL version data, and the data analysis section 208 analyzes the kind of the data, and the data generation section 209, among the versions indicated in the SSL version data, selects one version available in the PC 2 and generates SSL version selection data indicating it. And, the data transmission section 210 transmits it to the PC1 (Step S2).

When the SSL version selection data from the PC2 is received by the data receiving section 207, the PC1 decides to adopt an SSL of the versions indicated therein as a protocol for the target communication. The PC2 also decides similarly.

Next, the PC2 transmits the X.509 digital certificate to the PC1. If the X.509 digital certificate is not a one signed by the well-known authentication server 5, the PC2 transmits a chain of the certificates to the authentication server 5. The PC1 stores beforehand a route certificate for verifying the authentication server 5 itself and verifies whether there is the signed X.509 certificate received from the PC2 in it or not. Further, the PC1 confirms whether the concerned certificate is recorded in the certificate revocation list (CRL) issued by the authentication server 5 having signed it or not, and if it is recorded there, the communication is terminated at that time (Step S3).

If the authentication process aforementioned is cleared, thereafter, the PC2 notifies the PC1 of completion the response (Step S4).

Upon receipt of the notification of completion of the response from the PC2, the PC1 generates a pre-master key having a random value of 384 bits to generate a shared key to be used in the SSL communication. The data generation section 209 of the PC1 encrypts the pre-master key by the public key of the PC2 included in the X.509 certificate received from the PC2 and transmits it to the PC2 (Step S5).

Further, the PC1, on the basis of the pre-master key, generates a shared key to be actually used for encryption of data and controls so as to switch the encryption key for communication to the shared key. Further, the PC1 transmits to the PC2 an encryption switching notification indicating switching of the encryption key (Step S6).

Upon receipt of the notification of completion of switching the encryption key from the PC1 (Step S7), the PC2 also transmits the notification of switching the encryption key to the PC1 to switch the encryption key (Step S8). The data receiving section 207 of the PC2 decodes the pre-master key encrypted by its own public key which is received from the PC1 by the corresponding own secrete key. When the data analysis section 208 analyzes it, thereby confirms that the data kind is a pre-master key, the data handling section 204 generates a shared key on the basis of the received pre-master key, and hereafter, controls so that encrypted communication by the shared key is executed between itself and the PC1. Namely, the encryption key is switched.

When the encryption key is finished in switching, the PC2 transmits the notification of completion of switching of an encryption key to the PC1 (Step S9).

By the aforementioned processes, the connection of the SSL communication is established between the PC1 and the PC2. By doing this, the target communication can be executed safely.

Further, in the connection establishment aforementioned, although the case that the X.509 certificate of the PC2 is confirmed by the PC1 is described, there is a case that the X.509 certificate of the PC1 is confirmed simultaneously by the PC1. This is called SSL client authentication communication.

To execute the SSL client authentication communication between the PCs and between the PCs and the authentication server, each node needs to have the X.509 certificate and also needs to have a route certificate to verify the certificate.

As described above, the nodes 2 of the network 1 can perform the operation of communicating safely as nodes mutually verified.

### [Encrypted Communication Processing]

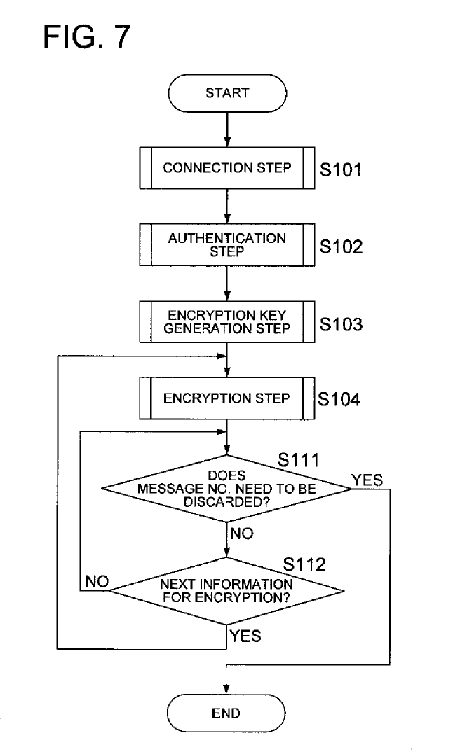

As already described, the nodes 2 of this embodiment are supposed to take a simple communication form such as the UDP without establishing sessions to maintain a multicast communication to a plurality of nodes 2 directly or indirectly associated. The flow of the encrypted communication processing of this embodiment for maintaining such a simple procedure and establishing encrypted communication will be described below by referring to FIG. 7.

FIG. 7 is a flow chart showing the flow of the encrypted communication processing method of this embodiment.

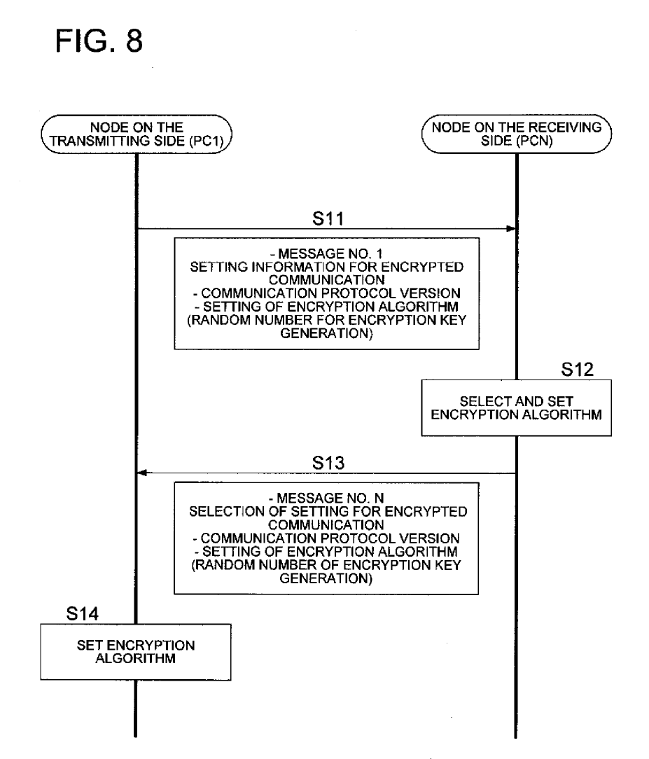

Step S101 shown in FIG. 7 is a connection step, and the message numbers are exchanged in the step. Using as an example the case where the node PC1 on the transmitting side is to execute a multicast transmission to the plurality of nodes (any of the nodes will be referred to as PCN) on the receiving side, the connection step will be described in detail by referring to FIG. 8.

This connection step may be individually executed for all the nodes (any PCN) on the receiving side. The succeeding authentication step at Step S104 and encryption key generating step at Step S103 may be similarly individually executed. An encryption step at Step S104 is executed by multicast, and it is executed for all the nodes (all the PCNs) on the receiving side. Therefore, the above-mentioned three steps have to be completed at all the nodes on the receiving side before that step.

### [Connection Step]

FIG. 8 shows the flow of the detailed process at the connection step at Step S101 shown in FIG. 7. The connection step is executed by the connection setting section 205a functioning as a determination section of the authentication section 205.

Firstly, at Step S11 shown in FIG. 8, the connection setting section 205a starts the processing for encrypted communication establishment. The PC1 transmits a message including a message number (hereinafter, may be referred to as message No.) and setting information for encrypted communication to the PC2. By doing this, between the PC1 and the PCN, the message number is determined.

The setting information for encrypted communication includes the version of the communication protocol and settings concerning the encryption algorithm. In the settings concerning the encryption algorithm, the information (random numbers for encryption key generation, etc.) necessary to generate an encryption key from the pre-master key which will be described later is included.

The message No. is a number assigned to all messages transmitted from the PC1 until it is destroyed as described later, and the message No. is assumed as 1 here. Therefore, after reception of the message No. 1, any of the PCNs confirms the message No. assigned to a received message, and if it is the message No. 1, the PC2 finds that the message is transmitted from the PC1. Therefore, this eliminates the handshaking every time when a message is transmitted or received.

The message No. is favorably determined to be a unique number for each transmitting node or for each combination of nodes for transmission and reception. The message number may be determined to be unique for every handshake of a multicast transmission by the encrypted communication. In this embodiment, the message number is determined to be unique for each transmitting node.

After receiving the setting information for encrypted communication, at Step S12, the PCN selects and sets a version which is available in the PCN on the basis of the version data of the received communication protocol. Further, the PCN selects and sets the algorithm supported by the PC2 on the basis of the received setting of the encryption algorithm.

At Step S13, each of the PCNs transmits a message including the setting and selection for encrypted communication to the PC1. As setting and selection for encrypted communication, the version of the selected communication protocol and setting information of the encryption algorithm are included. And, the message is attached with the message No.

Each setting information of the encryption algorithm which has been received from each of the PCNs together with a message No. N includes random number for encryption key generation. However, data received from any of the PCNs is desired to include one or more shared random numbers for encryption key generation.

Further, the reason of attachment of the message No. is the same as the reason of attachment of message No. 1 to a transmission message of the PC1, and the message number is assumed as 2 here. Hereinafter, to each of the all messages transmitted from any of the PCNs, the message No. N is attached. Similarly to the message No. 1 of the PC1, by the message No. N assigned to a message, it is found that each of the messages is a one transmitted from any of the PCNs.

At Step S14, after receiving the setting and selection for encrypted communication, the PC1 sets the version to be used by the PC1 on the basis of the version setting of the received communication protocol. Further, the PC1 sets the algorithm of the PC1 on the basis of the setting of the received encryption algorithm. Further, the PC1 stores the message No. N for the subsequent encrypted communication as a number representative of the transmission message from each PCN.

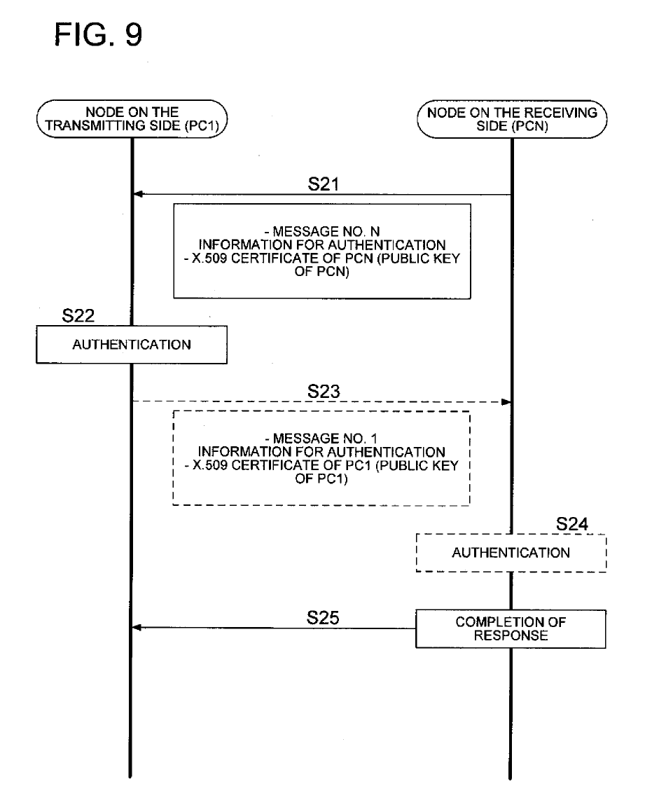

The description will return to FIG. 7. Step S102 following the connection step at Step S101 is an authentication step, in which the information necessary to authenticate each node is transmitted and received to authenticate each node. Using as an example the case where the node (PC1) on the transmitting side is to authenticate the node (any PCN) on the receiving side, the authentication step will be described in detail by referring to FIG. 9.

### [Authentication Step]

In FIG. 9, the flow of the detailed process at the authentication step at Step S102 shown in FIG. 7 is shown. The authentication step is executed by the authentication process section 205b of the authentication section 205.

At Step S21 shown in FIG. 9, firstly, any of the PCNs transmits a message including information for authentication to the PC1 together with the message No. N of the PCN. The information for authentication is the X.509 digital certificate of each of the PCNs including the information of the public key of each of the PCNs.

The public key is used to transfer and receive safely the pre-master key at the next encryption key generation step. The reason of transmission of the X.509 certificate and the authentication method by the certificate are the same as those of the SSL communication already described. If the X.509 certificate is not a one signed by the well-known authentication server 5, the chain of the certificates to the authentication server 5 is also transmitted.

At the next Step S22, each of the PCNs is authenticated on the basis of the X.509 certificate received by the PC1.

The PC1 stores beforehand a route certification for authenticate the authentication server 5 itself and verifies whether there is the signed X.509 certificate received from each of the PCNs in it or not. Further, the PC1 confirms whether the concerned certificate is recorded in the certificate revocation list (CRL) issued by the authentication server 5 having signed it or not, and when it is recorded, the communication is terminated at that time.

In the above description, although the PC1 authenticates each of the PCNs on the basis of the X.509 certificate of each of the PCNs, any the PCNs also may authenticate PC1 mutually on the basis of the X.509 certificate of the PC1. In this case, both of the PC1 and any of the PCNs have to have the X.509 certificates and the route certificates for verifying the respective certificates.

The next Steps S23 and S24 may be omitted. They are steps at which any of the PCNs authenticates the PC1.

At Step S23, this time, the PC1 transmits a message including the information for authentication to each of the PCNs together with the message No. 1 of the PC1. The information for authentication is similarly the X.509 digital certificate of the PC1 including the information of the public key of the PC1.

The public key is used to transmit and receive safely the pre-master key at the next encryption key generation step. If the X.509 certificate is not a one signed by the well-known authentication server 5, the chain of the certificates to the authentication server 5 is also transmitted.

At the next Step S24, the PC1 is authenticated on the basis of the X.509 certificate received by any of the PCNs. The authentication method is the same as the authentication of the PCN by the PC1 (Steps S21, S22).

At Step S25, after finishing the authentication process aforementioned, each of the PCNs notifies the PC1 of completion of the response. Upon receipt of the notification of completion of the response of each of the PCNs, the PC1 starts the next encryption key generation step.

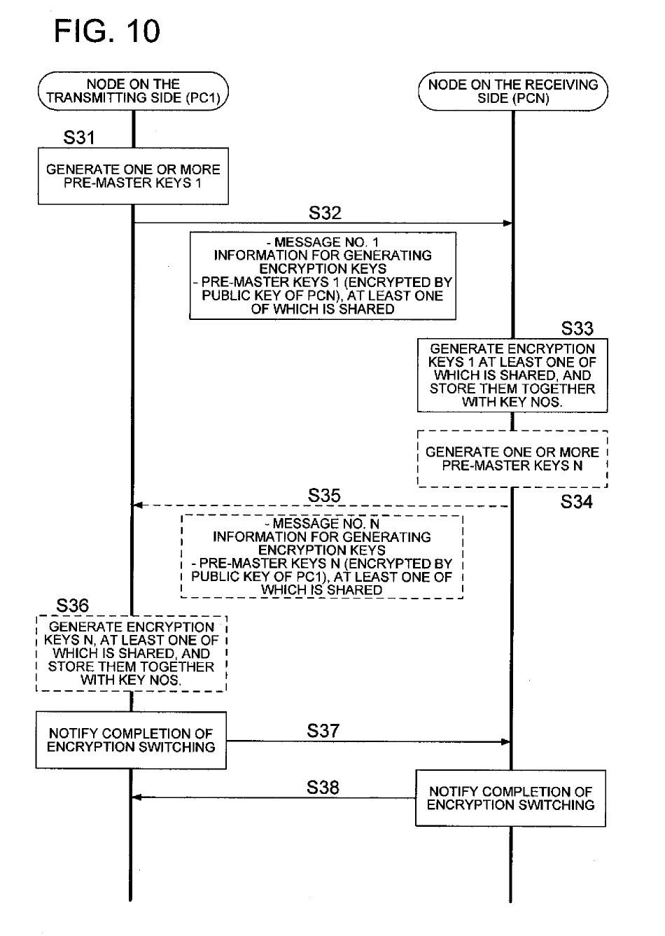

The description will return to FIG. 7. Step S103 following the authentication step at Step S102 is a step of encryption key generation, in which the information for generating an encryption key is transmitted and received and the encryption key is generated and shared. Using as an example the case where an encryption key as a shared key is generated and shared when the node (PC1) on the transmitting side executes the encrypted multicast communication with the nodes (any PCN) on the receiving side, the encryption key generation step will be described in detail by referring to FIG. 10.

### [Encryption Key Generation Step]

FIG. 10 shows the flow of the detailed processing at the encryption key generating step at Step S103 shown in FIG. 7. The encryption key generating step is executed by the encryption key generator 205c of the authentication section 205.

At Step S31 shown in FIG. 10, firstly, the PC1 generates a plurality of random pre-master keys for generating a plurality of encryption keys for any of the PCNs.

Using the pre-master keys and the information of random numbers for encryption key generation included in the setting information for the encrypted communication transmitted at the connection step, encryption keys are generated.

Here, as a pre-master key for any of the PCNs, a plurality of pre-master keys 1-1, 1-2, and 1-3 are assumed to be generated. The pre-master keys are transmitted to the PCN, and the PC1 and PCN are supposed to generate and hold the same encryption keys (shared keys) 1-1, 1-2, and 1-3.

Note that the pre-master keys are set such that at lease one or more of the encryption keys generated by the pre-master keys is shared with each of the PCNs. This is for the multicast communication of encrypted data to be performed afterward. It is assumed here that an encryption key 1-1 generated by the pre-master key 1-1 is a shared encryption key for each of the PCNs.

At the next Step S32, the PC1 transmits a message including the information for generating an encryption key to the PC2 together with the message No. 1 of the PC1. The information for generating an encryption key includes the plurality of pre-master keys 1-1, 1-2, and 1-3 generated at Step S31.

The plurality of pre-master keys are encrypted each using the public key of the PCN as a transmission destination. The public key of the PCN is included in the information for authentication of the PCN which is acquired by the PC1 at the authentication step.

At Step S33, the PCN decrypts the plurality of pre-master keys 1-1, 1-2, and 1-3 which are received by any of the PCNs (encrypted by the public key of the PCN itself) using the secrete key stored in the PC2 itself. Furthermore, on the basis of the decrypted plurality of pre-master keys 1-1, 1-2, and 1-3 and the random numbers for encryption key generation received from the PC1 at the connection step of Step S11, the PCN generates encryption keys 1-1, 1-2, and 1-3.

The generated plurality of encryption keys are used both for encryption and decryption, and the same keys are held in the PC1 and PCN. Further, as described above, at least one encryption key is an encryption key shared with each of the PCN, and the encryption key 1-1 is assumed to be the shared encryption key. Needless to say, also in the PC1, using the same pre-master keys and the random numbers for encryption key generation, the same shared keys 1-1 and 1-2 are generated and shared by each of the PCNs.

The shared keys 1-1 and 1-2 and the encryption key No. are shared with each of the PCNs and PC1 and stored in the respective data storage sections 203 associated with the message No. 1 assigned to the pre-master keys which are the bases of the shared keys.

The PC1, when transmitting the message, designates the message No. (specifically the transmission source of encrypted communication, PC1 in this case) and the encryption key No., thereby can identify and refer to the encryption key used for encryption. Further, each of the PCNs, when receiving the message, can identify and refer to the encryption key to be used for decryption since the message No. (similarly, the transmission source of encrypted communication, that is, PC1) and encryption key No. are designated.

Further, in the above description, although described is the case where the PC1 and any of the PCNs generate the same encryption keys by the same plurality of pre-master keys and the random numbers for encryption key generation, only one of the nodes may generate the encryption key. In that case, the encryption key is generated, for example, by any of the PCNs using the public key of the PC1, and the encryption key may be returned to the PC1 together with the message No. to be decrypted by the PC1, thus both the PC1 and any of the PCNs may share the same encryption key.

In the above description, the PC1 transmits the information for generating the encryption key to the PCN and permits each of the PCNs to generate an encryption key for an encrypted multicast communication from the PC1 to the PCN. Alternatively, the same encryption key may be used for encrypted communication from each of the PCNs to the PC1. Otherwise, it is also possible to use an encryption key different from that for the encrypted communication from the PC1 to the PCN to further improve the security. For example, there can be added a procedure where information for generating an encryption key is also transmitted from the PCN to the PC1 to generate another encryption key for an answer by encrypted communication from the PCN to the PC1.

Namely, the subsequent Steps S34, S35, and S36 are reverse steps of the Steps S31, S32, and S33 aforementioned, and higher security can be obtained by use of different encryption keys for a multicast transmission and its return. The encryption keys for the answer may be omitted, and in such a case, the aforementioned encryption keys 1-1 and 1-2 are also used in the answer from any of the PCNs to the PC1.

At Step S34, similarly to Step S31, the PCN generates pre-master keys for generating encryption keys. Further, at least one or more of pre-master keys generated in each of the PCNs is desired to be shared with each of the PCNs. This is to maintain similarity that the answers having the same encryption key are all the answers of the multicast transmission from the PC1. In order to generate a shared pre-master key, for example, date of reception may be used.

Here, pre-master keys N−1 is assumed to be generated as a shared pre-master key. The pre-master key is to be transmitted to the PC1, and the PC1 and PCN are to generate and share the same encryption key N−1.

At the next Step S35, each of the PCN transmits a message including the information for generating encryption keys to the PC1 together with the message No. N of each of the PCNs. The information for generating encryption keys includes the pre-master key N−1 generated at Step S34.

Further, similarly to Step S32, the pre-master key to be transmitted is encrypted using the public key of the PC1 which is a transmission destination. The public key of the PC1 is included in the information for authentication of the PC1 which is acquired by the PCN at the authentication step.

At Step S36, the PC1 decrypts the pre-master key N−1 (encrypted by the public key of the PC1 itself) received by the PC1 using the secrete key stored by the PC1 itself.

Furthermore, the PC1 and PCN generate the encryption key N−1 on the basis of the decrypted pre-master key N−1 and the aforementioned random number for encryption key generation.

Needless to say, also in the PCN, the same encryption key N−1 is generated using the same pre-master key and the random numbers for encryption key generation. Or, as mentioned above, it is possible to generate a encryption key by only one of the nodes, for example, only by the PC1, and to transmit it by encryption from the PC1 to the PCN to share it.

The encryption key No. of the generated encryption key N−1 is associated with the message No. N attached to the pre-master key which is the bases for the shared key, thereby, is stored and shared in each of the data storage sections 203 of each of the PC1 and PCNs.

The PCN, when transmitting the return message to the PC1, designates the message No. (specifically the transmission source of encrypted communication, PCN in this case) and the shared key No., thereby the PCN can identify and refer to the encryption key to be used for encryption. Further, when receiving the message, because the message No. (similarly, the transmission source, that is, PCN) and encryption key No. are designated, the PC1 can identify and refer to the encryption key to be used for decryption.

In the above description, the form where different encryption keys are shared depending on the transmission direction between the PC1 and each of the PCNs is adopted, and for that purpose, the PC1 and PCN use different pre-master keys. However, it is possible to use the same pre-master key and to generate different encryption keys by using different random numbers for encryption key generation.

In this case, the same pre-master key has only to be used, and Steps S34 and S35 aforementioned are unnecessary. In place of them, at Step S36, the PC1 generates the encryption key N−1 on the basis of the pre-master key 1-1 and the random numbers for encryption key generation (different from the random numbers used by the PCN at Step S33) received from each of the PCNs at the connection step at Step S13. However, at least one of the random numbers for encryption key generation received from each of the PCNs has to be in common. By using, for example, the method of Step S34 where date is used to generate a shared pre-master key, shared random numbers for encryption key generation have only to be generated in each PCN also at Step S13 and to be transferred to the PC1.

This encryption key N−1, of course, is generated also in the PCN, or it is transmitted from the PC1 to the PCN, and it is stored in each of the data storage sections 203 of each node and shared as a encryption key N−1.

Next, at Step S37, the PC1 controls so as to switch the encryption key for the multicast communication to at least one of the encryption keys which have been generated as mentioned above and are shared with each of the PCNs. Further, the PC1 transmits an encryption switching notification for indicating switching of the encryption key for communication to any of the PCNs. Further, when the encryption key switching aforementioned is finished, the PC1 transmits the notification of completion of switching an encryption to any of the PCNs.

Upon receipt of the notification of completion of the encryption switching from the PC1, also each of the PCNs, in order to switch the encryption key, transmits the notification of switching an encryption to the PC1 and switches the encryption key to be used for encrypted communication. Further, when the encrypted key switching is completed, each of the PCNs transmits the notification of completion of switching an encryption to the PC1.

Due to the aforementioned completion of encryption switching in all the PCNs, the PC1 finishes the establishment of encrypted communication and goes on to the encrypted communication processing of an actual multicast transmission of data.

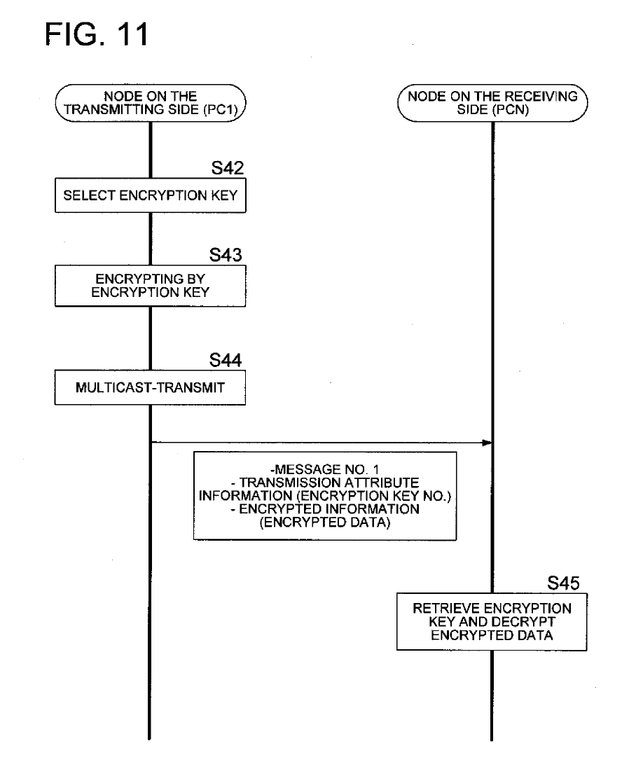

The description will return to FIG. 7. The Step S104 following the encryption key generating step at Step S103 is an encryption step and executes data communication encrypted on the basis of the encryption keys. Using as an example the case where the node on the transmitting side (PC1) transmits encrypted data to the plurality of nodes on the receiving side (PCNs) by multicast, the encryption step will be described in detail by referring to FIG. 11.

### [Encryption Step]

FIG. 11 shows the flow of the detailed processing at the encryption step at Step S104 shown in FIG. 7. The encryption step is executed by the encryption process section 205d of the authentication section 205.

At Step S42 of FIG. 11, the PC1 selects an encryption key (a encryption key shared with each of the PCNs which must be plural) associated with the message No. 1 of the PC1 for the data to be encrypted and multicast-transmitted. Encryption key No. 1 is selected here, which means the encryption key 1-1 is referred from the data storage section 203.

Next, at Step S43, the PC1 performs the encryption process using the selected encryption key for the data to be multicast-transmitted. Namely, the transmission data is encrypted by the encryption key 1-1, shared key No. 1, and shared key No. 2 respectively.

Next, at Step S44, the PC1 multicast-transmits the encrypted data to all of the nodes on the receiving side (all the PCNs) together with the message No. 1 of the transmission source PC1. The transmission here is performed by a simple communication protocol such as the UDP. The encryption keys have been shared beforehand, so that there is no need for the handshaking which causes a reduction in the communication speed, and a high-speed multicast communication can be maintained. Further, a plurality of shared encryption keys are prepared, the security can be improved by changing the encryption keys every time a multicast communication is executed.

The encrypted information to be transmitted includes the encrypted data and the transmission attribute information attached therewith, and the transmission attribute information is the number of the encryption key (here, for example, the encryption key No. 1) having been used for encryption of the data. The size of the encrypted information is desirably less than the size which can be transmitted at a time by the protocol used for transmission such as the UDP.

At Step S45, each of the PCNs searches the data storage section 203 based on the transmission attribute information (encryption key number) of the received encrypted information and the message No. and identifies and refers to the encryption key having been used for the encryption process of the data. For example, the PC searches the encryption key 1-1 based on the assigned message No. 1 and encryption key number (the encryption key No. 1).

The PCN, using the encryption key retrieved in this way, decrypts the encrypted data included in the received encrypted information.

The description will return to FIG. 7. When the encryption step at Step S104 is finished, the apparatus only waits for the next chance of encrypted communication. In this embodiment, encryption keys are set beforehand for the plurality of nodes on the receiving side, and the shared encryption keys are applied to the data to be multicast-transmitted, thus the improvement of the security is realized while securing the communication form capable of the multicast communication. However, whole the plurality of shared encryption keys which are set beforehand and shared are renewed at appropriate timing, thus the security can be further improved. For that purpose, at the timing of completion of encryption step of Step S104, adopted is a processing procedure where it is checked whether the plurality of shared and stored encryption keys should be renewed.

### [Re-Establishment Process of Encrypted Communication]

At Step S111, the PC1 decides whether or not to discard the message number. Discard of the message No. is to discard the encryption key associated with the message number. To perform a new encrypted communication processing, it is necessary to start again from the connection step and try again from the operation of setting a new message number.

Whether or not to discard the message No. is judged depending on whether the predetermined conditions are satisfied or not. The conditions for deciding the timing of discard may be considered as follows.

1. When a predetermined time period has passed after the aforementioned handshaking for establishment of encrypted communication, the message number is discarded.

2. When the power source of the PC1 is turned off, the message number is discarded.

3. When the connection with the corresponding PC of handshaking is interrupted, the message number is discarded.

4. When the encryption of the corresponding PC of handshaking cannot be decrypted, the message number is discarded.

5. The message number is discarded by an instruction of a user.

It is desirable to select and set appropriate conditions from the above conditions or other conditions.

When discard is decided in view of the set conditions (YES at Step S111), the setting of encrypted communication established by the above processing is once finished. When the situation of encrypted communication is to be performed again, the aforementioned establishment of encrypted communication is tried again from the Start shown in FIG. 7. Namely, when the aforementioned set conditions are satisfied, the encryption keys need to be generated again for security.

When non-discard is decided in view of the set conditions (NO at Step S111), the process goes to Step S112 and waits for transmission data for encryption. Namely, at Step S112, the it is decided whether there is the next transmission data to be encrypted or not, and when there is (YES at Step S112), the process returns to Step S104 and repeats the processing from the encryption step.

If there is not the next transmission data to be encrypted (NO at Step S112), the process returns to Step S111 to repeat Steps S111 and S112 and waits for the next transmission data for encryption while checking whether it is the timing of discard of the message number.

As mentioned above, by performing again the handshaking, that is, changing the encryption key itself in appropriate timing, the security can be further improved.

An example of the multicast transmission will be described bellow.

### [Example 1 of a Multicast Transmission of Encrypted Data]

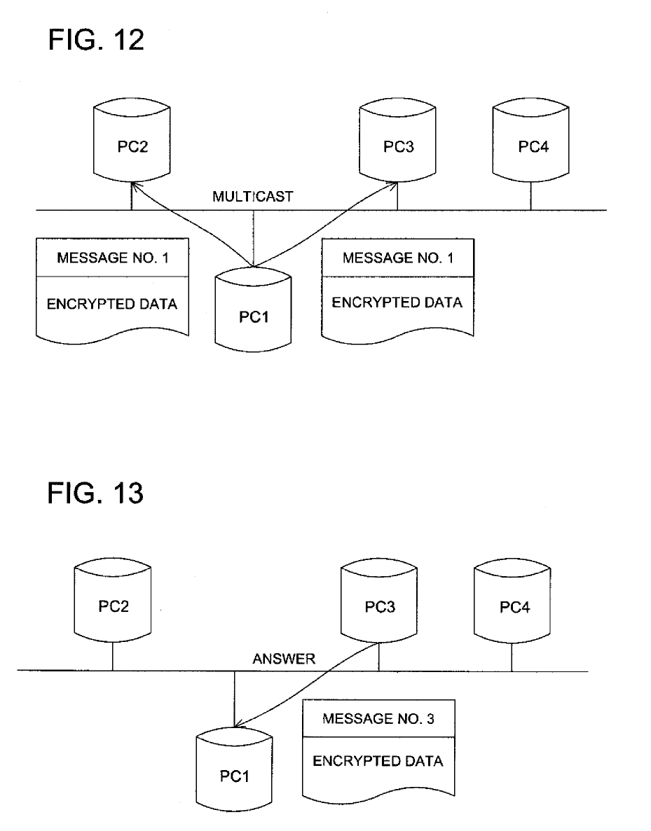

FIG. 12 is a diagram showing the Example 1 of an actual data transmission according to this encrypted communication processing.

The PC1 through PC4 are network-connected, the PC1 as a node on the transmitting side is assumed to multicast-transmit encrypted data to the PC2 and PC3 as nodes on the receiving side by the UDP communication.

In the above description, any of the PCNs corresponds to each of the PC2 and PC3. The handshake described above is executed for the PC2 and PC3 as follows to establish a connection for an encrypted communication.

In the connection step, setting information is exchanged for the encrypted communication. In particular, the version of the communication protocol and the encryption algorism are selected, and the message number of each node is stored in each node.

The message No. is a unique number for each node, and is always attached to a message to be a means to identify the transmission source of the massage, and is the information for searching the encryption key having been used. Here, the message No. for the PC1 as the node on the transmitting side is a message No. 1, and the message No. for each node (PC2 and PC3) on the receiving side is a message No. 2 and No. 3.

In the authentication step, each node (PC2 and PC3) on the receiving side is authenticated based on the digital certificate of each node. Further, the public key of each node is exchanged between the PC1 on the transmitting side and the PC2 and PC3 on the receiving side.

In the encryption key generation step, the PC1 on the transmitting side transmits pre-master Keys to each of the PC2 and PC3 on the receiving side after encrypting the pre-master keys by the public key of each of the PC2 and PC3. Upon receiving the pre-master keys, the PC2 and PC3 decrypt the received pre-master keys by each own secret key.

Each of the PC2 and PC3 generates encryption keys by using the decrypted pre-master keys. Note that at least one of the encryption keys to have been generated by the PC2 and PC3 is the same for the PC2 and PC3. The pre-master keys which have been set to function that way are transmitted from the PC1 to the PC2 and PC3. Here, just one encryption key (referred to as an encryption key 1) is assumed to be generated and to be the same for the PC2 and PC3.

The handshake for encryption communication is completed in the above-mentioned procedure, and encryption of data and a multicast transmission are to be executed at the succeeding encryption step (see FIG. 12).

The PC1 encrypts the transmission data by using the encryption key 1 and attach the message No. 1 to the encrypted information (encrypted data) to multicast-transmit to the PC2 and PC3. In this case, because the number of the shared key with the transmitting side and the receiving side is only one, the encryption key No. is not transmitted.

Upon receiving the encrypted information, each of the PC2 and PC3 decrypts the decrypted data based on the encryption key 1 associated with the message No. 1.

Further, for example, when the PC3 answers back to the PC1, the PC3 transmits data encrypted by the same encryption key 1 together with the message No. 1 associated with the encryption key 1. Upon receiving the response, the PC1 identifies the encryption key 1 and decrypts the encrypted data sent back from the PC3.

Otherwise, when another encryption key 3 has been generated based on the message No. 3, as shown in FIG. 13, the PC3 has only to transmit, together with the message No. 3, the data encrypted by the encryption key 3 associated with the message No. 3.

As described above, by using another encryption key for the return message from the PC3, the encrypted communication with further improved security can be realized.

### [Example 2 of a Multicast Transmission of Encrypted Data]

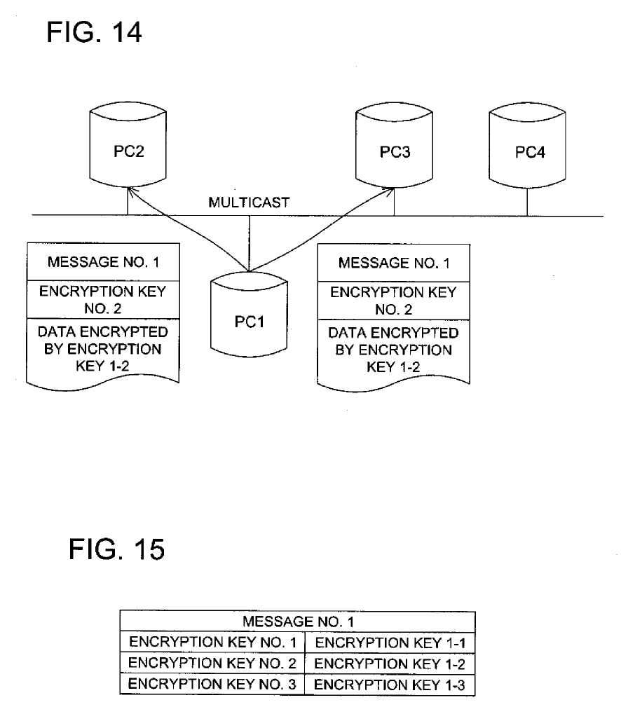

FIG. 14 is an explanatory diagram showing the Example 2 of an actual data transmission according to this encrypted communication processing.

Similarly to the Example 1 of the transmission, the PC1 trough PC4 are network-connected, the PC1 as a node on the transmitting side is assumed to multicast-transmit encrypted data to the PC2 and PC3 as nodes on the receiving side by the UDP communication.

The PC1 establishes a connection for an encrypted communication similarly to Example 1.

Similarly, the setting information is exchanged at the connection step.

The message No. for the PC1 as the node on the transmitting side is a message No. 1, and each node (PC2 and PC3) on the receiving side is a message No. 2 and No. 3.

At the authentication step, each node (PC2 and PC3) on the receiving side is authenticated by the digital certificate of each of the PC2 and PC3. Further, the encryption key of each node is exchanged between the PC1 and the PC2 and PC3.

In the encryption key generation step, the PC1 on the transmitting side transmits pre-master Keys to each of the PC2 and PC3 on the receiving side after encrypting the pre-master keys by the public key of each of the PC2 and PC3. Upon receiving the pre-master keys, the PC2 and PC3 decrypt the received pre-master keys by each own secret key.

The PC2 and PC3 generate encryption keys by using each decrypted pre-master keys. Note that a plurality of encryption keys are generated in the PC2 and PC3, three of the encryption keys are the shared encryption keys 1-1, 1-2 and 1-3 which are the same for the PC2 and PC3. Each of the PC2 and PC3 attaches the encryption key No. to these encryption keys and stores the encryption keys with the message No. 1 (see FIG. 15).

The connection for encrypted communication is established in the above-mentioned procedure, and encryption of data and multicast-transmission are executed at the succeeding encryption step (see FIG. 14).

The PC1 selects an encryption key to be used for transmission data from the above-mentioned shared encryption keys 1-1, 1-2 and 1-3. For example, the PC1 encrypts the transmission data by using the encryption key No. 2 (encryption data 1-2), attaches the message No. 1 and the encryption key No. 2 to the encrypted information (encrypted data), and then multicast-transmits it to the PC2 and PC3.

Upon receiving the encrypted information, each of the PC2 and PC3 refers to the encryption key No. 2 associated with the message No. 1, and can decrypt the encrypted data by using the identified encryption key 1-2.

Although the encryption key No. 2 is used in this Example 2, it can be more difficult to guess the used encryption key if the encryption key to be used is changed for every each multicast. Further, a new handshake to get a new encryption key is not needed, and the performance is not deteriorated.

In the embodiment aforementioned, in the inter-node multicast communication on the network, by first setting encryption keys shared with a plurality of nodes on the receiving side and applying them to each packet to be multicast-transmitted, effective encryption communication with improved security is possible while securing the communication form capable of multicast.

The apparatus and method for encrypted communication according to the embodiment of the present invention, in the inter-node multicast communication on the network, by first setting at least one or more of encryption keys, it can be avoided to use a fixed encryption key or to deteriorate, by procedure for encrypted communication, the condition where the multicast communication is possible.

Further, the scope of the present invention is not limited to the embodiment aforementioned. Without departing from the spirit of the present invention, modified embodiments are included within the scope.

What is claimed is:

1. A method for encrypted communication process for performing encrypted communication between a plurality of nodes constituting a network system, the method comprising the steps of:
determining a message number between a first node and a plurality of second nodes on a receiving side;
causing the first node to authenticate each of the second nodes;
communicating a first information for generating an encryption key between the first node and the each of the second nodes when the first node has successfully authenticated the each of the second nodes;
generating an encryption key based on the first information to share the encryption key between the first node and the second nodes;
causing the first node to encrypt a second information based on the encryption key and to multicast to the second nodes a message and the message number, the message including the encrypted second information.

2. The method of claim 1, wherein a plurality of the encryption keys are shared, and the first node generates an encrypted information based on an encryption key selected from the plurality of the encryption keys.

3. The method of claim 2, comprising the step of:
causing the first node to change, for each information to be encrypted, an encryption key to be used for encryption from one encryption key to another in the plurality of the encryption keys.

4. The method of claim 2, wherein the encrypted second information is provided with a transmission attribution information for identifying the encryption key used for the encryption of the second information.

5. The method of claim 1, wherein the message number is uniquely determined for each transmitting node or each combination of a transmitting node and a receiving node.

6. The method of claim 1, wherein the message number is discarded at a predetermined timing, and another message number is determined for a next communication.

7. The method of claim 1, wherein the each of the second nodes transmits a certificate for authentication to the first node.

8. The method of claim 7, wherein the certificate includes a public key corresponding to a secret key held by the each of the second nodes, and the first information for generating the encryption key is encrypted by using the public key and transmitted from the first node to the each of the second nodes.

9. The method of claim 1, where the encryption key is stored in a memory section in correspondence with the message number.

10. An encrypted communication processing apparatus as a node of a network system for performing encrypted communication between a plurality of nodes, the apparatus comprising:
a determination section which is adapted to determine a message number between the apparatus and a plurality of other nodes;
an authentication section which is adapted to authenticate each of the other nodes based on first information received from the plurality of other nodes;
an encryption key generating section which is adapted to, when the each of the plurality of other nodes has been successfully verified, communicate a second information for generating an encryption key to the plurality of other nodes, to generate an encryption key based on the second information, and to share the encryption key between the apparatus and the plurality of other nodes; and
an encrypting section which is adapted to encrypt a third information based of the encryption key and to multicast to the plurality of other nodes a message and the message number, the message including the encrypted third information.

11. The encrypted communication processing apparatus of claim 10, wherein the encryption key generating section shares a plurality of the encryption keys with the plurality of other nodes, and the encrypting section generates the third information encrypted based on an encryption key selected from the plurality of the encryption keys.

12. The encrypted communication processing apparatus of claim 11, comprising:
a changing section which is adapted to change, for each information to be encrypted, an encryption key to be used by the encrypting section for encryption from one encryption key to another in the plurality of the encryption keys.

13. The encrypted communication processing apparatus of claim 11, wherein the encrypting section provides the encrypted third information with a transmission attribute information for identifying the encryption key used for the encryption of the third information.

14. The encrypted communication processing apparatus of claim 10, wherein the determination section determines a unique value as the message number between the apparatus and the plurality of other nodes.

15. The encrypted communication processing apparatus of claim 10, wherein the determination section discards the message number at a predetermined timing, and determines another message number when another communication with the plurality of other nodes is to be performed.

16. The encrypted communication processing apparatus of claim 10, wherein the authentication section receives from the each of the plurality of other nodes a certificate for authentication of the each of the plurality of other nodes.

17. The encrypted communication processing apparatus of claim 16, wherein the certificate includes a public key corresponding to a secret key held by the each of the plurality of other nodes, and the encryption key generating section encrypts the second information for generating the encryption key by using the public key and transmits the encrypted second information to the each of the plurality of other nodes.

18. The encrypted communication processing apparatus of claim 10, comprising:
a memory section which is adapted to store the encryption key in correspondence with the message number.
